(19) United States
(12) Patent Application Publication
(10) Pub. No.: US 2003/0005690 A1
(43) Pub. Date: Jan. 9, 2003

(54) Energy reservoir for hydraulic systems

(76) Inventors: Ottmar Neuf, Reinbek (DE); Rainer Bavendiek, Wentorf (DE); Recep Macit, Dusseldorf (DE)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/093,083

(22) Filed: Mar. 7, 2002

(30) Foreign Application Priority Data
Mar. 8, 2001 (DE) 101 11 233.5

(51) Int. Cl. F16D 31/02

(52) U.S. Cl. 60/404

(57) ABSTRACT

The invention relates to a device and method to provide energy for hydraulic systems. The device includes at least one gas generation cartridge (2) and a device (5) for the activation of a gas generation. Gas pressure vessels (2) or pyrotechnic gas generation cartridges (2) can be used advantageously as gas generation cartridges (2). The method of the invention includes activating a gas generation when the pressure in a hydraulic circuit drops.

### CROSS-REFERENCE TO RELATION APPLICATION

This application corresponds to German Application No. 101 11 233.5 filed Mar. 8, 2001, which is herein incorporated by reference.

### BACKGROUND OF THE INVENTION

1. Field of the Invention

This invention relates generally to a device and a method to provide energy for hydraulic systems and, in one embodiment, to an emergency hydraulic pressure device for a hydraulic system.

2. Technical Considerations

The use of pressure reservoirs as energy storage devices for hydraulic systems is known. If a hydraulic system requires an additional supply of energy, the prior art teaches that energy can be made available from a pressure reservoir. In that case, the conventional pressure reservoir has a gas cushion under pressure on one side, a membrane in the middle, and the hydraulic medium on the other side. These systems have a limited useful life on account of the changing pressure load exerted on the membrane. For this reason, the systems of the prior art are maintenance-intensive and expensive.

Therefore, it is an object of the invention to provide an energy reservoir which makes it possible to easily and economically have a supply of energy for a hydraulic system that is available when needed.

### SUMMARY OF THE INVENTION

The invention teaches that there is at least one gas generation device, e.g., a gas generation cartridge, as well as means for the activation of the gas generation device. Consequently, energy is available for the hydraulic system when needed. By means of the gas generation cartridges, pressure is built up only when necessary to be supplied to the hydraulic system and can then be transmitted to the hydraulic medium.

The invention teaches that a gas generation cartridge filled with an inert gas can be provided. It is thereby ensured that the gas that generates the pressure does not react with the hydraulic medium.

In an additional configuration of the invention, a membrane is provided which is located between the gas generation cartridge and the hydraulic medium. As long as no energy supply from the energy reservoir is required, there is normally no load on the membrane, because the membrane is preferably in contact against the wall of a container or vessel that contains the hydraulic medium, among other things. In this vessel, the membrane separates the hydraulic medium from the gas generation cartridge, which can be installed in an outward bulge or recess in the wall of the vessel.

Preference is given to the use of a gas pressure vessel as the gas generation cartridge. Particular preference is given to the use of a gas pressure vessel filled with carbon dioxide. Commercially available carbon dioxide pressure vessels can be used advantageously. Carbon dioxide also has the advantage that it is an economical gas.

In an additional advantageous configuration of the invention, a pyrotechnic cartridge can be used as the gas generation cartridge. For example, a pyrotechnic cartridge of the type used in vehicle airbag systems can be used.

One advantage of the invention is that the gas generation cartridge pressurizes the space in which it is located for a certain length of time. The gas chamber adjacent the cartridge which is defined by or bounded by the membrane thereby expands, as a result of which the pressure is transmitted to the hydraulic medium which is located on the other side of the membrane and, therefore, additional energy is available if required, for example, for the movement of a machine driven by the hydraulic system. It is particularly advantageous if the device of the invention has one or more gas generation cartridges. A plurality of gas generation cartridges can be used with particular advantage, for example, as redundant systems to improve the reliability of the device.

It is further advantageous that the pressure can be increased very rapidly when necessary, for example by means of an electrical activation of the gas generation device.

In terms of the method, the invention teaches that a gas generation is activated (i.e., a gas is generated) when the pressure in a hydraulic circuit decreases. The gas generation can be advantageously activated when the pressure drops below a predefined limit. It is thereby advantageous to define the limit in advance.

A gas generation cartridge can be used to generate the gas. Particular preference is given to the use of a gas generation cartridge filled with inert gas. It is thereby ensured that the gas that generates the pressure does not react with the hydraulic medium.

Alternatively, a membrane can be inserted between the gas generation cartridge and a hydraulic medium. After the gas generation is activated, this membrane acts as a partition between a gas chamber on the cartridge side of the membrane and,the hydraulic medium on the other side of the membrane, as a result of which a wider range of gases can be used for the method since the gas does not come into contact with the hydraulic medium.

In one configuration of the invention, the pressure in the hydraulic circuit is measured and the measurements are transmitted to a control system.

If at least one pressure value is below a specified limit, the control system can activate the gas generation. For example, the gas generation can be activated electrically.

It is advantageous if, when the gas generation is activated, the gas is discharged into a vessel, the interior of which can be placed in communication with the hydraulic circuit. It is particularly advantageous if the vessel is connected to the hydraulic circuit so that the pressure increase in the vessel caused by the gas generation counteracts the pressure drop in the hydraulic circuit.

It is particularly advantageous if one or more gas generation cartridges can be used, including in particular a combination that can include a gas pressure vessel and a pyrotechnic cartridge, for example.

The advantages of the invention include the fact that it eliminates the need for conventional and maintenance-intensive pressure reservoirs and, therefore, occupies less space than systems that do require conventional pressure reservoirs. An additional advantage of the invention is that it very rapidly and reliably makes a large quantity of energy available in emergencies.

An additional advantage is that when the energy reservoir of the invention is used, no pressure is applied to the membrane from the side of the energy reservoir as long as no energy is required from the energy reservoir of the invention. Thus, the components of the hydraulic system are subjected to a lower load than in conventional systems. The invention also increases the reliability of a hydraulic system, for example in terms of the need for repairs and maintenance.

The invention can be used in a wide variety of applications. Examples include its use in hydraulic, pneumatic, and electro-hydraulic systems in which a specified quantity of energy is needed one time and for a short period. An additional exemplary application of the invention is its use in industrial trucks to compensate for load peaks that are caused by uneven spots in the road or floor and which act on the load being transported.

### BRIEF DESCRIPTION OF THE DRAWINGS

The invention is explained in greater detail below with reference to the exemplary embodiments illustrated in the accompanying schematic drawings, in which:

FIG. 1 is a side, sectional view of a device of the invention to provide energy for a hydraulic system; and

FIG. 2 is a side, sectional view of another device of the invention with a membrane to provide energy for a hydraulic system.

### DESCRIPTION OF THE PREFERRED EMBODIMENTS

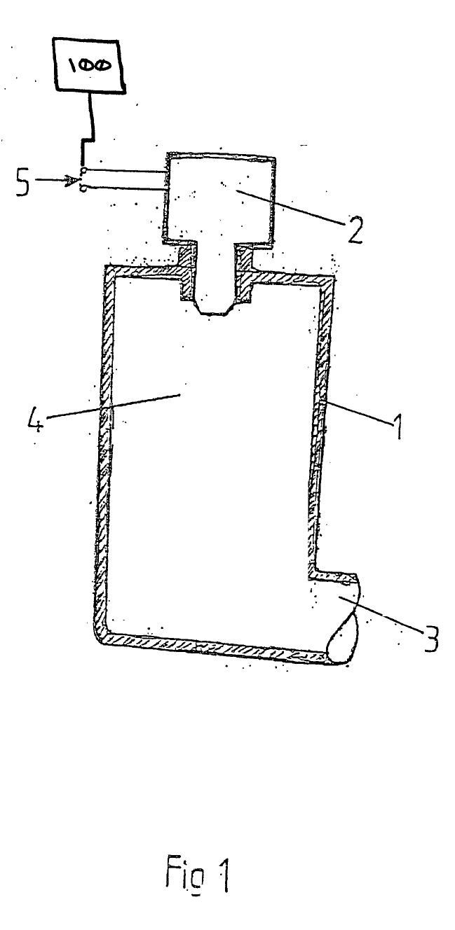

FIG. 1 shows a vessel or housing 1 as part of a hydraulic system with a gas generation device, e.g., a gas generation cartridge 2, and a connecting pipe 3. The space 4 contains hydraulic medium. The connecting pipe 3 can be used to place the hydraulic medium in the housing 1, e.g., in the space 4, in flow communication with the other components of the hydraulic system, e.g., with the hydraulic fluid in the rest of the hydraulic system. The energy is provided by the energy stored in the gas generation cartridge 2. The gas generation cartridge 2 can be connected to a control system 100 which can activate the cartridge 2, e.g., upon sensing a decrease of hydraulic pressure in the hydraulic system. The gas generation can be activated by any conventional activation device in any conventional manner, e.g., electrically. For this purpose, there can be an electrical activation system 5 connected to the cartridge 2. After the gas generation cartridge 2 is activated, energy is transmitted from the gas being discharged via the increasing pressure in the space 4 to the hydraulic medium in the housing 1. This increase in pressure can be transmitted to the hydraulic medium in the rest of the hydraulic system through the connecting pipe 3.

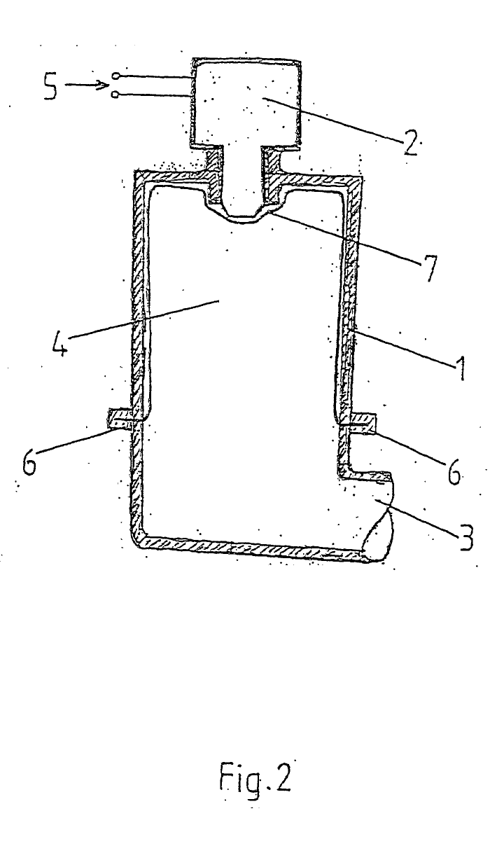

FIG. 2 shows another embodiment of a device of the invention having a housing 1 as part of a hydraulic system with a gas generation cartridge 2 and a connecting pipe 3. A membrane 7, e.g., a flexible membrane, separates the space 4 for the hydraulic medium on one side of the membrane 7 from a space adjacent the gas generation cartridge 2 on the other side of the membrane 7. The membrane 7 can be fastened to the housing 1 by any conventional fastening means 6, such as bolts, screws, pressure fit, etc. The gas generation can be triggered by an electrical activation system 5. The increasing pressure on the side of the membrane 7 adjacent or facing the gas generation cartridge 2 after the activation of the gas generation pushes the membrane 7 toward the hydraulic medium in the space 4 and thereby transmits energy to the hydraulic medium in the rest of the hydraulic circuit through the connecting pipe 3. The use of the separating membrane 7 has the advantage that gases that may not come into contact with the hydraulic medium can also be used for the gas generation.

When necessary, for example in the event of a failure of a component of the hydraulic system that entails a pressure loss, the hydraulic system can continue to be operated for a limited period of time by energy supplied by the energy reservoir of the invention. In such a case, it is advantageous if the quantity of stored energy is sufficient to move a machine that has a hydraulic system into a safe position, e.g., into a position in which repairs can be performed.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A device to provide energy for hydraulic systems, comprising:
at least one gas generation cartridge; and
means for activation of a gas generation.

2. The device as claimed in claim 1, wherein the gas generation cartridge is filled with an inert gas.

3. The device as claimed in claim 1, including a membrane located between the gas generation cartridge and a hydraulic medium.

4. The device as claimed in claim 1, wherein the gas generation cartridge includes a gas pressure vessel.

5. The device as claimed in claim 4, wherein the gas pressure vessel is filled with carbon dioxide.

6. The device as claimed in claim 1, wherein the gas generation cartridge includes a pyrotechnic cartridge.

7. A method of providing energy for hydraulic systems, comprising:
activating a gas generation when a pressure in a hydraulic circuit drops.

8. The method as claimed in claim 7, including generating the gas by a gas generation cartridge.

9. The method as claimed in claim 7, including measuring the pressure in the hydraulic circuit and transmitting the measurements to a control system.

10. The method as claimed in claim 9, including activating the gas generation by the control system when at least one measured pressure value is below a specified limit.

11. The method as claimed in claim 7, wherein after the gas generation is activated, gas is conveyed from the gas generation cartridge into a vessel.

12. The method as claimed in claim 11, wherein the vessel is in communication with the hydraulic circuit so that the pressure increase in the vessel caused by the gas generation counteracts the pressure decrease in the hydraulic circuit.

13. A device to provide emergency hydraulic pressure to a hydraulic system, comprising:
a vessel having an interior, with the vessel interior connectable with a hydraulic system;
at least one gas generation device connected to the vessel; and
an activation device connected to the gas generation device,
wherein upon activation of the gas generation device the generated gas is directed into the interior of the vessel to pressurize hydraulic fluid in the interior of the vessel, and wherein the pressurized hydraulic fluid is in flow communication with the hydraulic system.

14. The device as claimed in claim 13, including a flexible membrane located in the vessel interior and dividing the vessel interior into a first space adjacent the gas generation device and a second space containing the hydraulic fluid.

15. A method of providing emergency hydraulic pressure to a hydraulic system, comprising:
connecting a vessel having an interior to a hydraulic system;
connecting at least one gas generation device to the vessel;
activating the gas generation device upon detection of an emergency situation to direct gas from the gas generation device into the interior of the vessel to pressurize hydraulic fluid in the interior of the vessel; and
placing the pressurized hydraulic fluid in the vessel in flow communication with the hydraulic system.
